(19) United States
(12) Patent Application Publication
(10) Pub. No.: US 2013/0135088 A1
(43) Pub. Date: May 30, 2013

(54) METHODS AND SYSTEMS FOR INDICATING AN OPEN DOOR IN AN AUTOMOTIVE VEHICLE

(71) Applicant: Jayanthi GovindaRao Simha, Cupertino, CA (US)

(72) Inventor: Jayanthi GovindaRao Simha, Cupertino, CA (US)

(21) Appl. No.: 13/307,940

(22) Filed: Nov. 30, 2011

(51) Int. Cl. B60Q 1/00

(52) U.S. Cl. 340/425.5

(57) ABSTRACT

Methods and systems for indicating a door open in an automotive vehicle are provided. Sensors mounted on the automotive vehicle sense an open door and start a timer. After the timer expires, an indication is sent to one or more user devices about the door being open for a period of time. The indication may be sent by a wireless transmitter to a user device equipped with a wireless receiver. The indication may also be sent by a Global System for Mobile communication (GSM) module to a cellular device. The indication may be one or more of an audio signal, a visual signal, a voice mail, a text message or an alert in a social network site.

### FIELD OF THE EMBODIMENTS

The described embodiments relate generally to automotive vehicles. More particularly, the described embodiments relate to methods, and systems for indicating at least one door open in an automotive vehicle.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many automotive vehicles are equipped with security alarm systems. Security alarm systems provide mechanisms for arming the automobile and indicating an intrusion. Generally all the doors of the automobile are required to be closed in order to lock the automobile and arm the security alarm system. There are instances when an automobile door is left open with no indication to the owner that the automobile door is open and unlocked. The trunk of an automotive vehicle may be left open and/or unlocked for a period of time after loading or unloading goods. When a door is open, the automobile may not be armed with a security alarm system there by vulnerable to theft. Accordingly, it is desirable to provide techniques for enabling an indication of an open automotive vehicle door.

### SUMMARY

One embodiment includes a method of indicating at least one door of an automotive vehicle being open by sensing the door open by a sensor and triggering a timer. An indication of at least a door open is sent to a user device after the timer expires.

In an embodiment, the indication is sent by a wireless transmitter to a wireless receiver on a user device. The indication may be in audio or visual format. In another embodiment, the indication may be sent by a Global System for Mobile (GSM) communication module to a cellular phone. The indication may be a voicemail or a text message or an alert on a social media website.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 shows a block diagram of an embodiment of a system of automotive vehicle door open indicator;

FIG. 2 shows a flowchart that includes the steps of an example of a method of indicating an open door.

FIG. 3 shows a flowchart that includes the steps of an example of a method of receiving by a user device, an indication of an open door of an automotive vehicle.

### DETAILED DESCRIPTION

The described embodiments are embodied in methods, and systems for indicating an open door in an automotive vehicle. These embodiments provide sensing a door open for a period of time and then sending an indication of an open door to a user device.

Next, systems and methods are provided for indicating an open door in an automotive vehicle and will be described with reference to example embodiments.

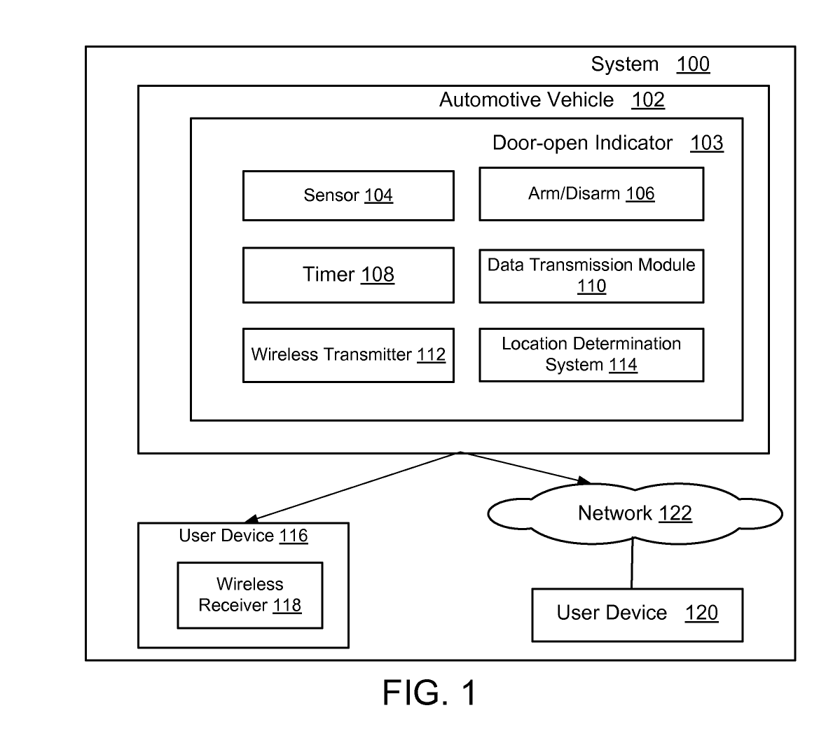

FIG. 1 shows an embodiment of system 100, a system for providing an indication of an open door in an automotive vehicle. In an embodiment, system 100 may host automotive vehicle 102, door-open indicator 103, sensor 104, arm/disarm 106, timer 108, data transmission module 110, wireless transmitter 112, location determination system 114, user device 116, wireless receiver 118, user device 120, and network 122. In other embodiments system 100 may not have all of the elements or features listed and/or may have other elements or features instead of or in addition to those listed.

Automotive vehicle 102 may be an automobile with the door open indicator among others. For the described embodiments, automobile and automotive vehicle may be used interchangeably and may mean a wheeled motor vehicle used for the transportation of passengers, goods, and/or animals. For the described embodiments, automobile may be a car or a truck with an engine using all of any of or a combination of petrol, diesel, electric, petroleum gas or any other kind of fuel.

Door-open indicator 103 may be a device with components for sensing a door open, a timer, a message transmitter such as a wireless transmitter to transmit signals to a wireless receiver and/or a GSM module to transmit message to a cellular device, a switch to turn on/off and optionally a location determination system. For the described embodiments, a door may be any door of the automobile, such as the door for passengers to board or alight the automotive vehicle, the door for the driver of the automotive vehicle, the trunk door, the door of a compartment holding goods and/or animals.

Sensor 104 may be a sensor for sensing a door open using an electrical system or a magnetic contact system or any other technology. Sensor 104 may be mounted near a door to sense the door open. Sensor 104 sends a signal to the timer after sensing the door open. In an embodiment, one or more sensors may be mounted on the automotive vehicle to sense one or more doors open. In an embodiment, the sensor may also indicate to the timer which door is open and the timer in turn may convey which door is open to the data transmission module or the wireless transmitter. In another embodiment, the sensor may indicate which door is open directly to the data transmission module or the wireless transmitter. Arm/disarm 106 may be a user interface to turn on or turn off door-open indicator 103. Turning on door-open indicator 103 arms automotive vehicle 102 with the door-open indicator. Turning off door-open indicator 103 disarms the automotive vehicle. The door-open indicator may be turned off when loading or unloading passengers or goods or animals for an extended period of time. In an embodiment, a switch may be provided on the door-open indicator to arm/disarm. In another embodiment, a user device with wireless transmitter may be used to arm/disarm door-open indicator 103. In an embodiment, arm/disarm 106 may be equipped with a wireless receiver to receive signals for arming/disarming the indicator.

Timer 108 may be a timer which may be started after receiving a signal from sensor 104. Timer 108 may be a programmable timer. The expiration of the timer may be set based on the type of the automotive vehicle or the type of cargo being carried. The output of the timer may trigger any of or all of or some of the notifying devices such as the wireless transmitter, data transmission module. In an example the timer may be set to expire after 8 minutes.

Data transmission module 110 may be an electronic component for sending data to a user device. In an embodiment, the data transmission module receives a signal/data from the timer indicating an open door for a period of time. In another embodiment, data transmission module 110 may receive which door of the automotive vehicle is open. In an embodiment, data transmission module 110 may receive the geographical location of the automotive vehicle.

Data transmission module 110 may be a Global System for Mobile communication (GSM) module similar to the ones on the cellular phones. In an embodiment, data transmission module 110 may be a GSM module with GSM modem. The GSM module may send and receive data through radio waves. The GSM module sends data to the user device such as a cellular phone or a smartphone via GSM network. Data transmission module 110 may transmit a standard message to a user device after receiving an input signal from the timer 108. In another embodiment, data transmission module 110 may send an alert to the user via a social networking site such as Facebook or Myspace. In another embodiment, data transmission module 110 may send a message to a central location providing security services. In another embodiment, data transmission module 110 may be a General Packet Radio Service (GPRS) module based on packet-switched technology. The GPRS module is an extension of the GSM technology with higher data transmission speed. The GPRS module sends data to the user device via GSM network. The GPRS module sends data to the user device such as a multimedia phone via GSM network. One or more user device numbers may be stored on data transmission module 110 so that the door-open indicator can send a message to one or more user devices. The message may be a text message or a pre-recorded voice mail. In an embodiment, the message may include the geographical location of automotive vehicle 102.

Wireless transmitter 112 may be a transmitter for transmitting radio frequency signals after receiving an input. The input may be received after sensing the door open after the expiration of the timer. Wireless transmitter 112 may send a message to the user device with a wireless receiver indicating a door open for a period of time. In an embodiment, wireless transmitter 112 receives a signal/data from timer indicating an open door for a period of time. In an embodiment, wireless transmitter 112 may receive which door of the automotive vehicle is open. In an embodiment, wireless transmitter 112 may receive the geographical location of the automotive vehicle. Wireless transmitter 112 may send a standard pre-programmed message. In an embodiment the message may include the geographical location of automotive vehicle 102.

Location determination system 114 may include a Global Positioning System (GPS) or any other means of determining a location of automotive vehicle 102. Location determination system 114 may transmit the geographical location of automotive vehicle 102 to user devices via wireless transmitter 112 and/or data transmission module 110.

User device 116 may be any user device such as a key fob, a dedicated receiver, or a multi-purpose user device with a wireless receiver. The user device receives a signal from the wireless transmitter 112 and outputs an indication of the automotive door open. The user device may be equipped with any of or all of or some of output indicators such as an audio indicator, visual indicator or a vibrator. An example audio indicator may be a single beep or a continuous beep or any other audio indication. An example visual indicator may be a flashing light or a text message. Wireless receiver 118 may be a dedicated wireless receiver or a multi-purpose receiver. Wireless receiver 118 may be part of user device 116.

User device 120 represents user systems which connect to automotive vehicle 102, via network 122. User device 120 may be a user device connected to a network and capable of receiving signals from the network. User device 120 may be a cellular phone or a smart phone or any device with a GSM/GPRS module and capable of receiving voice mail and/or a text message. User device 116 and user device 120 may communicate independently and simultaneously with door-open indicator 103. In an embodiment, user device 116 and user device 120 may be combined into a single device. In another embodiment, user device 120 may be a service center. The service center may in turn send a message to the owner of the vehicle.

Network 122 may be any network and/or combination of networks of devices that communicate with one another (e.g., and combination of the Internet, telephone networks, and/or mobile phone networks). Door-open indicator 103 may interact with any of a variety of user devices via network 122 using a network interface.

### Method of Using the Door-Open Indicator

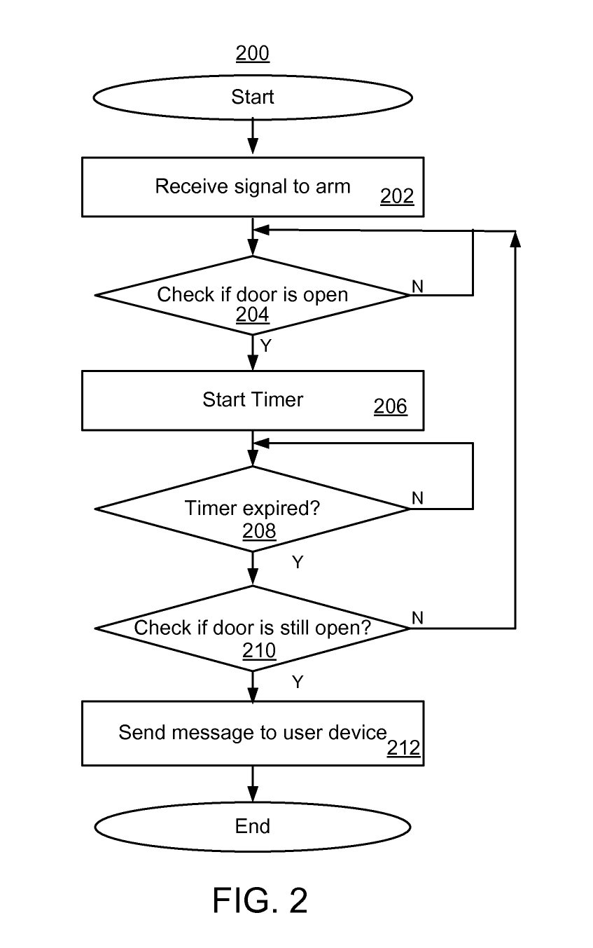

FIG. 2 shows a flowchart of an embodiment of a method 200 for using the door-open indicator. In step 202 the system receives a signal to arm the door-open indicator. The door-open indicator may be armed by manually turning on a switch in the automotive vehicle or by receiving a signal from a user device such a key fob or a dedicated user device with wireless receiver or a multi-purpose user device.

In step 204, method 200 checks the sensor for an open door and waits in step 204 until at least a door is open. If an open-door is sensed, then method 200 proceeds to step 206. In step 206, a timer is started. In step 208, the timer is checked for expiration. The expiration of the timer may be set based on the cargo or the type of automotive vehicle. Method 200 waits until the timer expires and then proceeds to step 210. In step 210, method 200 checks if the door is still open. If the door is not open, method 200 proceeds to step 204. If the door is open method 200 proceeds to step 212. In step 212, method 200 sends a message to one or more user devices indicating that the door of the automotive vehicle is open. The message may be an audio indication, visual indication, text message, a pre-recorded voice mail or an alert in a social network site. In an embodiment, the message may include the geographical location of automotive vehicle 102. In another embodiment, the message may include which door is open/

In an embodiment, each of the steps of method 200 may be a distinct step. In other embodiments, method 200 may not have all of the above steps and/or may have other steps in addition to or instead of those listed above. The steps of method 200 may be performed in another order. Subsets of the steps listed above as part of method 200 may be used to form their own method. In an embodiment, there could be multiple instances of method 200.

### User-Side Method

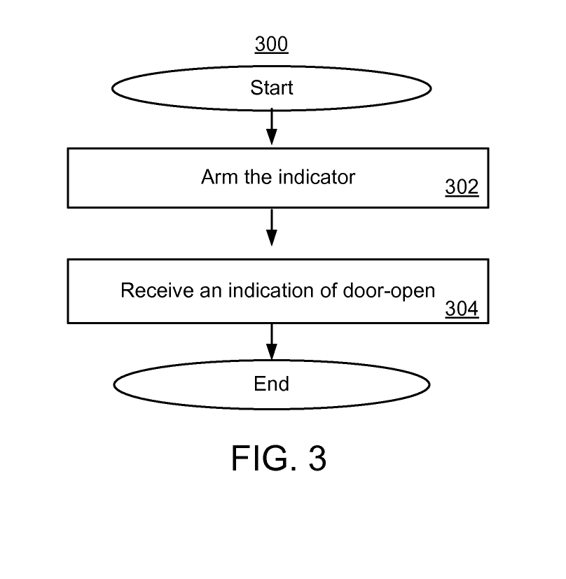

FIG. 3 shows a flowchart that includes the steps of an example of a method of receiving by a user device, an indication of an open door of an automotive vehicle. Method 300 may be performed by user device 116, or user device 120 and may be performed by a single device or different devices. In step 302, the user system sends a signal to the door-open indicator on the automotive device, arming the door-open indicator. The signal may be sent by a transmitter on a user device. In another embodiment, step 302 is optional; the door-open indicator may be armed by manually turning on a switch on the door-open indicator. In another embodiment, the switch may be anywhere on the automotive vehicle.

In step 304 the user device receives an indication of the automotive vehicle door open. In an embodiment, the indication may be an audio indicator such as a beep or a voice message, a visual indicator such as a flashing light or a light on or a vibration of the user device such as a key fob or any other user device. In another embodiment, the indication may be a text message on a mobile phone, a voice mail on a mobile phone or a phone connected via wires. In another embodiment, an app on a smartphone or a tablet computer may indicate the door open.

In an embodiment, each of the steps of method 300 may be a distinct step. In other embodiments, method 300 may not have all of the above steps and/or may have other steps in addition to or instead of those listed above.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system of indicating at least one door of an automotive vehicle being open, comprising:
a sensor for detecting the at least one door being open;
a timer for measuring time after sensing the door open;
a transmitter for sending an indication of the at least one door being open to a user device after the timer expires.

2. The system of claim 1, the transmitter for sending the indication of the at least one door being open being a wireless transmitter.

3. The system of claim 1, the transmitter for sending the indication of the at least one door being open being a Global System for Mobile (GSM) communication module.

4. The system of claim 1, further comprising a switch to turn off the sensor.

5. The system of claim 1, further comprising a location determination system to transmit geographical location of the automotive vehicle along with the indication of the at least one door being open.

6. A method of indicating at least one door of an automotive vehicle being open, comprising:
starting a timer after sensing the at least one door of the automotive vehicle being open;
sending an indication to at least one user device, that the at least one door of the automotive vehicle being open for a period of time, after the timer expires.

7. The method of claim 6, sending the indication by a wireless transmitter.

8. The method of claim 6, further includes sending a geographical co ordinates of the automotive vehicle.

9. The method of claim 6, the indication being a visual indication to the least one user device.

10. The method of claim 6, the indication being an audio indication to the least one user device.

11. The method of claim 6, the indication being a text message to the least one user device.

12. The method of claim 6, the indication being a voice mail to the least one user device.

13. The method of claim 6, the indication being an alert on a social network site.

14. The method of claim 6, the indication being sent to a central location.

15. The method of claim 6, further including sending an indication which door is open.
